(19) United States
(12) Patent Application Publication
(10) Pub. No.: US 2026/0303494 A1
(43) Pub. Date: Oct. 1, 2026

(54) SYSTEM AND METHOD FOR MONITORING AN EVENT IN A NON-CLUSTERED NETWORK

(71) Applicant: JIO PLATFORMS LIMITED, Ahmedabad, Gujarat (IN)

(72) Inventors: Aayush BHATNAGAR, Navi Mumbai, Maharashtra (IN); Anurag SINHA, Mumbai, Maharashtra (IN); Hardik Navinbhai BAVISHI, Navi Mumbai, Maharashtra (IN); Sandeep BISHT, Kalyan, Thane, Maharashtra (IN); Kumar Gaurav SINGH, Panvel, Maharashtra (IN); Nilesh SANAS, Navi Mumbai, Maharashtra (IN); Amit Kumar SINGH, Kalyan East, Maharashtra (IN); Raghvendra BHUSHAN, Kalyan, Thane, Maharashtra (IN); Mangesh Shantaram KALE, Navi Mumbai, Maharashtra (IN); Gaurav JAIN, Ghansoli, Maharashstra (IN)

(73) Assignee: JIO PLATFORMS LIMITED, Ahmedabad, Gujarat (IN)

(21) Appl. No.: 18/993,101

(22) PCT Filed: May 7, 2024
(86) PCT No.: PCT/IN2024/050493

§ 371 Date: Jan. 10, 2025

(30) Foreign Application Priority Data
May 30, 2023 (IN) 202321037378

(51) Int. Cl. H04L 43/08; H04L 41/34

(52) U.S. Cl. CPC H04L 43/08; H04L 41/34

(57) ABSTRACT

The present disclosure provides a system and a method for monitoring an event in a non-clustered network (314). The system facilitates a network exposure function (NEF) (304) in an asynchronous mode to send a monitoring request (MONTE) to a service capabilities exposure function (SCEF) (306) and a unified data manager function (UDM) (308) simultaneously. The NEF (304) communicates the request to the SCEF (306) internally over an interface between the NEF (304) and the SCEF (306) and initiates a UDM event monitoring request with the UDM (308).

### RESERVATION OF RIGHTS

A portion of the disclosure of this patent document contains material, which is subject to intellectual property rights such as but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The present disclosure generally relates to systems and methods for monitoring events in a telecommunication network. More particularly, the present disclosure relates to a system and a method for monitoring an event in a non-clustered network.

### BACKGROUND OF THE INVENTION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admission of the prior art.

Wireless communication technology has rapidly evolved over the past few decades. The first generation of wireless communication technology was analog technology that offered only voice services. Further, when the second-generation (2G) technology was introduced, text messaging and data services became possible. The 3G technology marked the introduction of high-speed internet access, mobile video calling, and location-based services. The fourth-generation (4G) technology revolutionized the wireless communication with faster data speeds, improved network coverage, and security. Currently, the fifth-generation (5G) technology is being deployed, with even faster data speeds, low latency, and the ability to connect multiple devices simultaneously.

The third generation partnership project (3GPP) involves handling of an evolved packet core (EPC) and a fifth-generation core (5GC) interworking. An architecture for direct unified data management (UDM) and home subscriber server (HSS) interworking is available. The UDM performs HSS discovery to discover an HSS that manages the user subscriptions in the evolved packet core (EPC). The UDM utilizes the network repository function (NRF) to discover the HSS instance(s) unless the information about HSS instances is available by other means, e.g. locally configured on the UDM. The HSS selection function in UDM selects an HSS instance based on the available HSS instances (obtained from the NRF or locally configured).

Further, a combined service capability exposure function (SCEF) and network exposure function (NEF) can configure monitoring events applicable to both EPC and 5GC using only 5GC procedures towards UDM. The SCEF+NEF indicates that the monitoring event is also applicable to EPC together with the SCEF identity, i.e. the event must be reported both by 5GC and EPC. However, if the HSS and UDM are deployed as separate network entities, the UDM uses the HSS services to configure the monitoring event in EPC. For events requiring reporting from mobility management entity (MME) towards SCEF or HSS, the UDM requests the configuration of the monitoring event in the EPC to the HSS. The common exposure scenarios are applicable for users having both EPC and 5GC subscription.

However, there is a need to have an explicit description of interaction between 4G and 5G nodes like SCEF and NEF nodes. Further, the there is a need to have information regarding an interaction between various Application Function (AF's) with NEF and SCEF through common application programming interface (API) framework (CAPIF). Thus, lack of explicit description of interaction between fourth generation (4G) and fifth generation (5G) nodes may create issues in communication.

Hence, there is a need for a system and a method that can mitigate the problems associated with the prior arts and provides enhanced communication between the various nodes of the network.

### DEFINITION

As used in the present disclosure, the following terms are generally intended to have the meaning as set forth below, except to the extent that the context in which they are used to indicate otherwise.

The term AF as used herein, refers to an application function. The AF is a control plane function within 5G core network, provides application services to the subscriber.

The term UDM as used herein, refers to unified data management. The UDM manages network user data in a single and centralized element.

The term NEF as used herein, refers to network exposure function. The NEF exposes unified application programming interface (APIs) to any other external business applications for interaction with the 5G network functions. It provides interfaces for monitoring, provisioning, and policy/charging functionalities in the 5G network.

The term AMF as used herein, refers to access and mobility management function. The AMF is responsible for managing access and mobility for 5G devices, and it interacts with other network functions such as the UPF (User Plane Function), SMF (Session Management Function), and AUSF (Authentication Server Function).

The term SCEF as used herein, refers to service capability exposure function. The SCEF is a product deployed in a Policy Management network that interacts with Internet of Things (IOT) devices as a machine type communication interworking function (MTC-IWF).

The term HSS as used herein, refers to home subscriber server. The HSS is the main database of the current generation's cellular communications systems. It contains subscriber-related information, such as the authentication information and the list of services to which each user is subscribed.

The term MME as used herein, refers to Mobility Management Entity. The MME is a key component in the 5G core network architecture. It plays a central role in managing the mobility and connection establishment for user devices (UEs) in a 5G network.

### OBJECTS OF THE INVENTION

It is an object of the present disclosure to provide a system and a method for monitoring non-clustered events in a network using a converged network exposure function (CNEF).

It is an object of the present disclosure to provide a system and a method where a network exposure function (NEF) is configured in an asynchronous mode to send a monitoring event (MONTE) request to a service capabilities exposure function (SCEF) and a unified data manager function (UDM) simultaneously.

It is an object of the present disclosure to provide a system and a method where the NEF is configured to send a request to the SCEF internally over an interface and initiate an UDM event exposure subscribe request.

It is an object of the present disclosure to improvise the network capabilities and system.

It is an object of the present disclosure to provide a robust system for communication and nodes management.

### SUMMARY

In an exemplary embodiment, the present invention discloses a method for monitoring an event in a non-clustered network. The method comprising receiving, by a network exposure function (NEF), an event monitoring request from an application function (AF). The method comprising responsive to receiving the event monitoring request, communicating, by the NEF, the event monitoring request to a service capabilities exposure function (SCEF) and a unified data management (UDM) event monitoring request to a UDM. The method comprising responsive to the UDM event monitoring request, receiving, by the NEF a UDM event monitoring response from the UDM and responsive to the event monitoring request, receiving, by the NEF, an event monitoring response from the SCEF. The method comprising receiving, by the AF, the event monitoring response from the NEF in response to the event monitoring request to allow monitoring of the event.

In an embodiment, the event monitoring request is communicated from the NEF to the SCEF over an interface between the NEF and the SCEF.

In an embodiment, the event monitoring response is communicated from the SCEF to the NEF over the interface.

In an embodiment, the NEF is configured to operate in an asynchronous mode when the UDM and a home subscriber server (HSS) are a part of the non-clustered network and fail to support internetworking.

In an embodiment, the NEF communicates the event monitoring request to the SCEF and the UDM simultaneously when the NEF is configured in the asynchronous mode.

In an embodiment, the method comprising responsive to receiving the event monitoring request, communicating, by the SCEF, a monitoring event subscription create request to the HSS and responsive to the monitoring event subscription create request, receiving, by the SCEF, a monitoring event subscription response from the HSS.

In an embodiment, the NEF is configured to receive a first monitoring event identifier (ID) and a second monitoring event ID, from the HSS and the UDM, respectively.

In an embodiment, the NEF is configured to receive an error message from the UDM/HSS, or the SCEF.

In an embodiment, the NEF is configured to perform an error handling procedure after receiving the error message.

In an embodiment, the error handling procedure includes determining if the error message is received due to a communication failure between the NEF and the SCEF or the UDM respectively.

In an embodiment, the error handling procedure includes determining if the error message is received due to the event monitoring request from the AF.

In an embodiment, the NEF is configured to send an error response message to the AF when it is determined that the error message is received due to the event monitoring request from the AF.

In an embodiment, the NEF is configured to retry sending the event monitoring request to the SCEF when it is determined that the error message is received due to the communication failure between the NEF and the SCEF.

In an embodiment, the NEF is configured to retry sending the event monitoring request to the UDM when it is determined that the error message is received due to the communication failure between the NEF and the UDM.

In an exemplary embodiment, the present invention discloses a system for monitoring an event in a non-clustered network. The system comprising a receiving unit configured to receive an event monitoring request, a database configured to store the event monitoring request, and a processing unit coupled to the receiving unit and the database. The processing unit is configured for receiving, by a network exposure function (NEF), an event monitoring request from an application function (AF). The processing unit is configured for responsive to receiving the event monitoring request, communicating, by the NEF, the event monitoring request to a service capabilities exposure function (SCEF) and a unified data management (UDM) event monitoring request to a UDM. The processing unit is configured for responsive to the UDM event monitoring request, receiving, by the NEF a UDM event monitoring response from the UDM and responsive to the event monitoring request, receiving, by the NEF, an event monitoring response from the SCEF. The processing unit is configured for receiving, by the AF, the event monitoring response from the NEF in response to the event monitoring request to allow monitoring of the event.

In an embodiment, the event monitoring request is communicated from the NEF to the SCEF over an interface between the NEF and the SCEF.

In an embodiment, the event monitoring response is communicated from the SCEF to the NEF over the interface.

In an embodiment, the NEF is configured to operate in an asynchronous mode when the UDM and a home subscriber server (HSS) are a part of the non-clustered network and fail to support internetworking.

In an embodiment, the NEF communicates the event monitoring request to the SCEF and the UDM simultaneously when the NEF is configured to operate in the asynchronous mode.

In an embodiment, responsive to receiving the event monitoring request, communicate, by the SCEF, a monitoring event subscription create request to the HSS and responsive to the monitoring event subscription create request, receive, by the SCEF, a monitoring event subscription response from the HSS.

In an embodiment, the NEF is configured to receive a first monitoring event identifier (ID) and a second monitoring event ID, from the HSS and the UDM, respectively.

In an embodiment, the NEF is configured to receive an error message from the UDM/HSS, or the SCEF.

In an embodiment, the NEF is configured to perform an error handling procedure after receiving the error message.

In an embodiment, the error handling procedure includes determining if the error message is received due to a communication failure between the NEF and the SCEF or the UDM respectively.

In an embodiment, the error handling procedure includes determining if the error message is received due to the event monitoring request from the AF.

In an embodiment, the NEF is configured to send an error response message to the AF when it is determined that the error message is received due to the event monitoring request from the AF.

In an embodiment, the NEF is configured to retry sending the event monitoring request to the SCEF when it is determined that the error message is received due to the communication failure between the NEF and the SCEF.

In an embodiment, the NEF is configured to retry sending the event monitoring request to the UDM when it is determined that the error message is received due to the communication failure between the NEF and the UDM.

In an exemplary embodiment, the present invention discloses user equipment (UE) communicatively coupled with a non-clustered network configured for monitoring an event. The coupling comprises receiving, by the non-clustered network, a connection request by the UE. The coupling comprises sending, by the non-clustered network an acknowledgment of the connection request to the UE and transmitting a plurality of signals in response to the connection request. The non-clustered network comprising one or more network elements for monitoring events. In an aspect, the one or more network elements include a network exposure function (NEF) and a service capability exposure function (SCEF). The NEF is configured to send an event monitoring request to a service capabilities exposure function (SCEF), and a unified data management (UDM) event monitoring request to a UDM. The event monitoring request to the SCEF is communicated through an interface between the NEF and the SCEF. A UDM event monitoring response is communicated to the NEF from the UDM responsive to the UDM event monitoring request. An event monitoring response is communicated from the SCEF to the NEF via the interface, responsive to the event monitoring request, to allow monitoring of events associated with the UE.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an exemplary network architecture for implementing a proposed system (108), in accordance with an embodiment of the present disclosure.

FIG. 2 illustrates an exemplary block diagram of a proposed system, in accordance with an embodiment of the present disclosure.

FIG. 3A illustrates an exemplary system architecture for implementing a proposed system, in accordance with an embodiment of the present disclosure.

FIG. 3B illustrates an exemplary flow diagram for communication between a network exposure function (NEF) network exposure function and a service capabilities exposure function (SCEF) for creating an event exposure subscription, in accordance with an embodiment of the present disclosure.

FIG. 4 illustrates an exemplary computer system in which or with which the embodiments of the present disclosure may be implemented.

FIG. 5 illustrates an exemplary flow diagram for a method for monitoring an event in a non-clustered network.

The foregoing shall be more apparent from the following more detailed description of the disclosure.

### LIST OF REFERENCE NUMERALS

100—Network architecture
102-1, 102-2 . . . 102-N—A plurality of users
104-1, 104-2 . . . 104-N—A plurality of computing devices
106—Network
108—System
200—Block Diagram
202—Receiving unit
204—Memory
206—Interfacing unit
208—Processing unit
210—Database
300A—System architecture
300B—Flow diagram
301—User equipment (UE)
302—Application function (AF)
304—Network exposure function (NEF)
306—Service capabilities exposure function (SCEF)
308—Unified data management (UDM)
310—Home subscriber service (HSS)
312—Data network (DN)
314—Network
400—A computer system
410—External storage device
420—Bus
430—Main memory
440—Read only memory
450—Mass storage device
460—Communication port(s)
470—Processor
500—Flow Diagram

### DETAILED DESCRIPTION

In the following description, for explanation, various specific details are outlined in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive like the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is to describe particular embodiments only and is not intended to be limiting the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any combinations of one or more of the associated listed items.

As the wireless technologies are advancing, there is a need to cope up with the 5G requirements and deliver a prominent level of service to the customers. Thus, faster communication between the network elements of a 5G communication network is becoming crucial day by day. The third generation partnership project (3GPP) involves handling of an evolved packet core (EPC) and a fifth-generation core (5GC) interworking. However, conventionally, there is lack of explicit description of interaction between 4G and 5G nodes like service capabilities exposure function (SCEF) and network exposure function (NEF) nodes. Further, there is a lack of information regarding an interaction between various Application Function (AF's) with NEF and SCEF through common application programming interface (API) framework (CAPIF). Thus, lack of explicit description of interaction between fourth generation (4G) and fifth generation (5G) nodes may create issues in communication.

Further, conventionally, the AF needs to support various application programming interface (APIs) such as N33 API and T8 API for the communication in the network.

Hence, there is a need for a system and a method that can mitigate the problems associated with the prior arts.

The present invention aims to overcome the above-mentioned and other existing problems in this field of technology by providing a system and a method that provides information regarding the interaction between AFs with NEF and SCEF through CAPIF for a faster and enhanced communication in the network.

In an aspect, a developer need not to develop the application programming interface (APIs) of N33 and T8 with NEF and SCEF respectively. The application can integrate on N33 with NEF only and communication with SCEF will be handled by NEF using the interface between the NEF and the SCEF. Further, the AF need not track the user equipment (UE) presence in the network for creating subscriptions. The tracking of UE presence is internally handled by NEF using the interface. Thus, the AF can get the notification reports irrespective of UE's network.

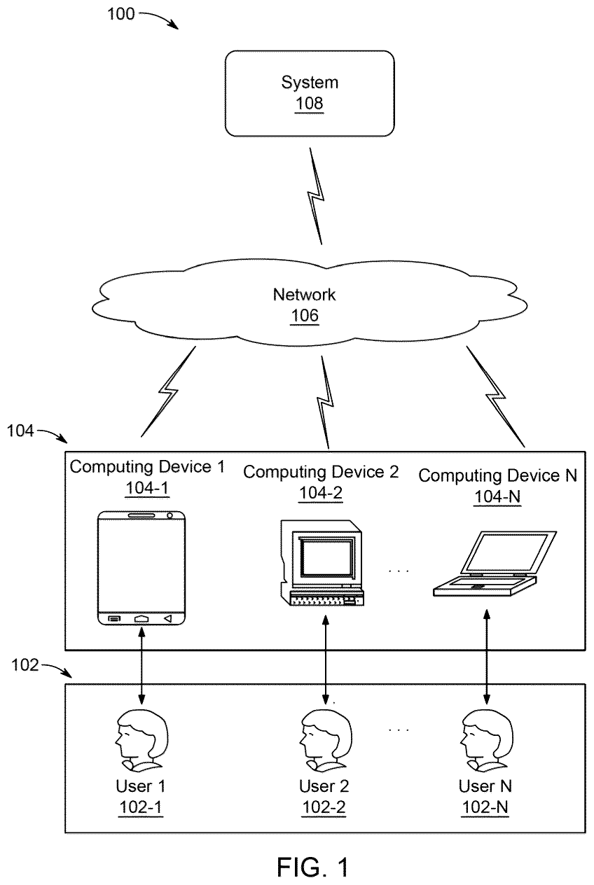

The various embodiments throughout the disclosure will be explained in more detail with reference to FIGS. 1-5.

FIG. 1 illustrates an exemplary network architecture (100) for implementing a proposed system (108), in accordance with an embodiment of the present disclosure.

As illustrated in FIG. 1, one or more computing devices (104-1, 104-2 . . . 104-N) may be connected to a proposed system (108) through a network (106). A person of ordinary skill in the art will understand that the one or more computing devices (104-1, 104-2 . . . 104-N) may be collectively referred as computing devices (104) and individually referred as a computing device (104). One or more users (102-1, 102-2 . . . 102-N) may provide one or more requests to the system (108). A person of ordinary skill in the art will understand that the one or more users (102-1, 102-2 . . . 102-N) may be collectively referred as users (102) and individually referred as a user (102). Further, the computing devices (104) may also be referred as a user equipment (UE) (104) or as UEs (104) throughout the disclosure.

In an embodiment, the computing device (104) may include, but not be limited to, a mobile, a laptop, etc. Further, the computing device (104) may include one or more in-built or externally coupled accessories including, but not limited to, a visual aid device such as a camera, audio aid, microphone, or keyboard. Furthermore, the computing device (104) may include a mobile phone, smartphone, virtual reality (VR) devices, augmented reality (AR) devices, a laptop, a general-purpose computer, a desktop, a personal digital assistant, a tablet computer, and a mainframe computer. Additionally, input devices for receiving input from the user (102) such as a touchpad, touch-enabled screen, electronic pen, and the like may be used.

In an embodiment, the network (106) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The network (106) may also include, by way of example but not limitation, one or more of a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof.

In an embodiment, the system (108) may receive the one or more requests from the users (102) via the computing devices (104). The one or more requests may include an event exposure subscribe request from the users (102). In an embodiment, the system (108) may monitor primary parameters such as, but not limited to, a loss of connectivity, a UE reachability, and a location report from the various UEs (104). The system (108) may access one or more network functions (NFs) to monitor one or more secondary parameters. The one or more secondary parameters may include, but not limited to, a roaming status, a communication failure, a downlink data notification failure, a packet data unit (PDU) session status, a number of UEs (104) in a geographical area, a core network (CN) type change, and a downlink data delivery status.

In an embodiment, the one or more NFs may include, but not limited to, an access and mobility function (AMF) and a unified data management function (UDM), and a session management function (SMF).

In an embodiment, the roaming status may be detected by the system (108) based on the UE (104) status using the UDM. Further, the system (108) may use the AMF and the UDM to determine the communication failure from the UE (104) based on a radio access network (RAN) or a non-access stratum (NAS) failure detection.

In an embodiment, the system (108) may use the AMF and the UDM to determine the downlink data notification failure. The downlink data notification failure may be detected by the system (108) when the UE (104) becomes reachable after a previous downlink data notification failure. An application function (AF) may request an idle status indicating the UE (104) reachability.

In an embodiment, the system (108) may use the SMF to determine if the PDU session is established or released.

In an embodiment, the system (108) may use the AMF and determine the number of UEs (104) in a geographical area. The AF may request the system (108) for a last known location of the number of UEs (104) in the geographical area and further determine the number of UEs (104) in a current geographical area.

In an embodiment, the system (108) may use the UDM and determine the core network (CN) type change when the UE (104) moves between an evolved packet core (EPC) and a fifth generation core (5GC). The CN type change indicates a CN type for a UE (104) or a group of UEs (104) while detecting that the UE (104) switches between being served by a mobile management entity (MME) or the AMF or when accepting an event subscription.

In an embodiment, the system (108) may use the SMF to determine the downlink data delivery status where one or more events may be reported to the SMF at a first occurrence of data packets being buffered, transmitted, or discarded.

In an embodiment, the system (108) may access one or more nodes based on the one or more primary parameters and the one or more secondary parameters. The one or more nodes may include, but not limited to, a fourth generation (4G) MME and a fifth generation (5G) home subscriber service (HSS).

In an embodiment, the system (108) may determine a loss of connectivity where the system (108) may observe that the UE (104) is no longer reachable for a signaling or a user plane communication. Further, in an embodiment, an AF configured in the system (108) may generate a maximum detection time that indicates a maximum period of time without any communication with the UE (104) after which the system (108) may determine that the UE (104) is unreachable.

In an embodiment, the system (108) may determine a UE (104) reachability based on one or more reporting parameters. The one or more reporting parameters may include, but not limited to, a maximum latency, a maximum response time, a number of downlink packets, and an idle status indication.

In an embodiment, the system (108) may determine a location reporting event based one or more detection parameters. The one or more detection parameters may include, but not limited to, a one-time reporting parameter, a maximum number of reports, maximum duration of reporting, and a periodicity parameter. Further, the system (108) may determine a current location or a last known location of the UE (104).

In an embodiment, the system (108) may use an interface, to communicate with the SCEF for creating an event exposure subscription. Furthermore, MONTE identifier (ID) may be received from a home subscriber server (HSS) and the UDM and separately handled by the CNEF. Further, for a scenario when the UDM and the HSS are not a part of cluster or do not support interworking, the NEF may be configured in an asynchronous mode to send the MONTE requests to the SCEF and the UDM simultaneously. The NEF may forward the request to SCEF internally over the interface and initiate the “UDM event exposure subscribe request” with the UDM.

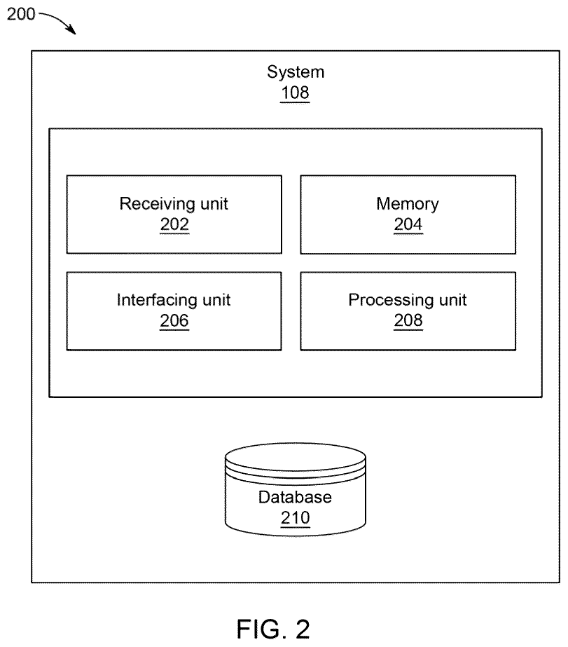

FIG. 2 illustrates an exemplary block diagram (200) of a proposed system (108), in accordance with an embodiment of the present disclosure.

Referring to FIG. 2, in an embodiment, the system (108) may include a receiving unit (202), a memory (204), an interfacing unit (206), a processing unit (208) and a database (210). The receiving unit (202) is configured to receive an event monitoring request, the database (210) is configured to store the event monitoring request. The processing unit (208) is coupled to the receiving unit (202) and the database (210). The processing unit (208) is configured to perform the monitoring of the events in the network.

The processing unit (208) may be implemented as one or more microprocessors, microcomputers, microcontrollers, digital signal processors, central processing units, logic circuitries, and/or any devices that process data based on operational instructions. Among other capabilities, the processing unit (208) may be configured to fetch and execute computer-readable instructions stored in a memory (204) of the system (108). The memory (204) may be configured to store one or more computer-readable instructions or routines in a non-transitory computer readable storage medium, which may be fetched and executed to create or share data packets over a network service. The memory (204) may comprise any non-transitory storage device including, for example, volatile memory such as random-access memory (RAM), or non-volatile memory such as erasable programmable read only memory (EPROM), flash memory, and the like.

In an embodiment, the interfacing unit (206) may comprise a variety of interfaces, for example, interfaces for data input and output devices (I/O), storage devices, and the like. The interfacing unit (206) may facilitate communication through the system (108). The interface(s) (206) may also provide a communication pathway for various components of the system (108).

In an embodiment, the processing unit (208) may receive the one or more requests from the users (102) via the computing devices (104). The processing unit (208) may store the one or more requests in the database (210). The one or more requests may include an event exposure subscribe request by the users (102). In an embodiment, the processing unit (208) may monitor primary parameters that may include, but not limited to, a loss of connectivity, a UE reachability, and a location report from the various UEs (104). The processing unit (208) may access one or more NFs to monitor one or more secondary parameters. The one or more secondary parameters may include, but not limited to, a roaming status, a communication failure, a downlink data notification failure, a PDU session status, a CN type, and a downlink data delivery status.

In an embodiment, the processing unit (208) may access one or more nodes based on the one or more primary parameters and the one or more secondary parameters. The one or more nodes may include, but not limited to, a 4G MME and a 5G HSS.

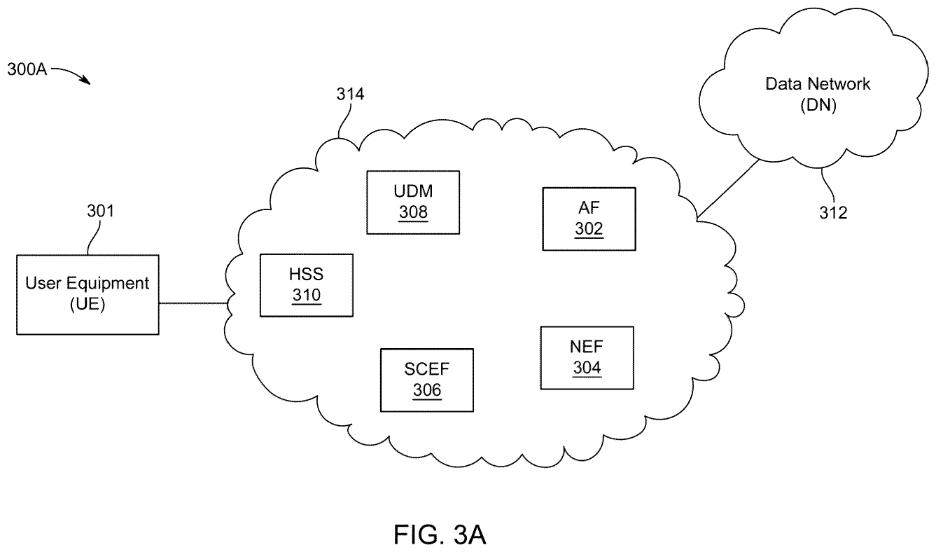

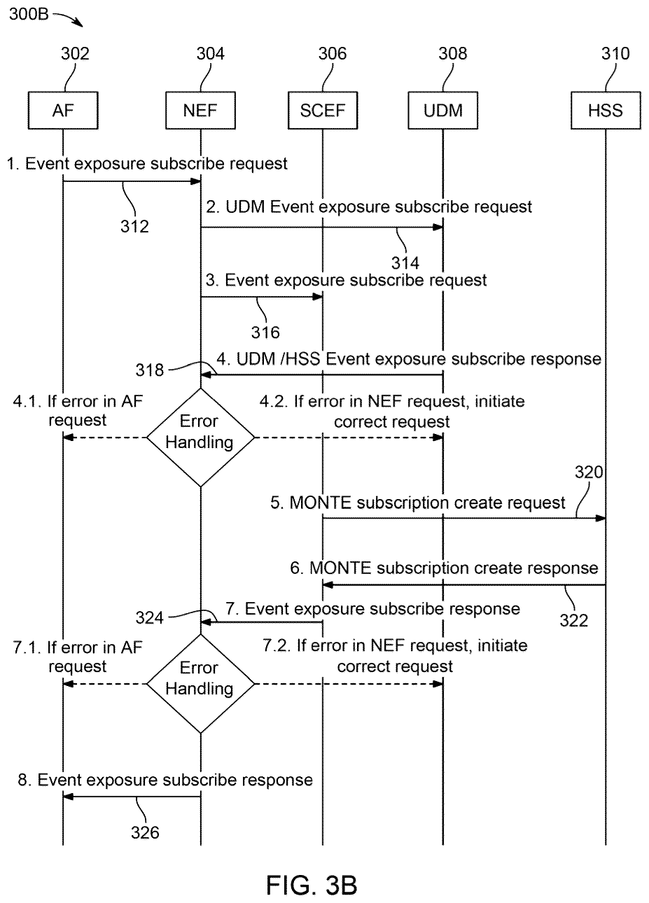

In an embodiment, the processing unit (208) may communicate with the SCEF for creating an event exposure subscription. Furthermore, a MONTE identifier (ID) may be received from a HSS and the UDM and separately processed by the processing unit (208) FIG. 3A illustrates an exemplary system architecture for implementing a proposed system, in accordance with an embodiment of the present disclosure.

In an aspect, the system architecture includes at least a user equipment (UE) (301) connected/coupled to the network. In an example, the network (314) may receive a connection request from the UE (301). The network (301) may send an acknowledgment of the connection request to the UE (301). The network (314) and the UE (301) may transmit a plurality of signals as a part of process of the connection. The network (314) may be a non-clustered network. The network may include a plurality of network elements. For example, the network may include an application function (AF) (302), a network exposure function (NEF) (304), a service capabilities exposure function (SCEF) (306), a unified data management (UDM) (308), and a home subscriber service (HSS) (310), The network (314) may be a non-clustered network as the nodes such as the UDM (308) and the HSS (310) are not part of a cluster. In a clustered network, nodes such as the AF (302), the NEF (304), the SCEF (306), the UDM (308), and the HSS (310) are grouped together into clusters for various purposes including but not limited to load balancing, redundancy, and fault tolerance. The network may be further connected to a data network (DN) (312). The DN (312) is related to the 3GPP 5G architecture and identifies service provider services, internet access or 3rd party services.

FIG. 3B illustrates an exemplary flow diagram for a communication between a NEF and a SCEF for creating an event exposure subscription, in accordance with an embodiment of the present disclosure. The events may include, but are not limited to a loss of connectivity, a UE reachability, location reporting, a roaming status, communication failure, packet data unit (PDU) session status, number of UEs present in a geographical area, a downlink data delivery status, and a core network (CN) type change.

As illustrated in FIG. 3B, the following steps may be implemented.

At step 1: At 312, the AF (302) may send an event exposure subscribe request to an NEF (304). In embodiments, the event exposure subscribe request may be an event monitoring request.

At step 2: At step 314, the NEF (304) may send a UDM event exposure subscribe request to a UDM (308). In embodiments, the event exposure subscribe request may be a UDM event monitoring request.

At step 3: At step 316, the NEF (304) may send an event exposure subscribe request to a SCEF (306) over an interface between the NEF (304) and the SCEF (306).

At step 4: At step 318, the UDM (308) may send a UDM/HSS event exposure subscribe response to the NEF (304). In an example, the UDM/HSS event monitoring response may refer to a response comprising access or approvals from the UDM (308) for exposing UDM events.

At steps 4.1 and 4.2: The NEF (304) is configured to receive an error message from the UDM (308)/HSS (310). In an embodiment, the NEF (304) is configured to perform an error handling procedure after receiving the error message. In an embodiment, the error handling procedure includes determining if the error message is received due to a communication failure between the NEF (304) and the UDM (308). In an embodiment, the error handling procedure includes determining if the error message is received due to the event monitoring request from the AF (302). In an embodiment, the NEF (304) is configured to send an error response message to the AF (302) when it is determined that the error message is received due to the event monitoring request from the AF (302). In a non-limiting example, if the error message is received due to an erroneous parameter provided by the AF (302), then the NEF (304) will respond to the AF (302) with the error response message. In an embodiment, the NEF (304) is configured to retry sending the event monitoring request to the UDM (308) when it is determined that the error message is received due to the communication failure between the NEF (304) and the UDM (308).

At step 5: At step 320, the SCEF (306) may send a MONTE subscription create request to a HSS (310). In examples, the MONTE may refer to monitoring event. The MONTE subscription create request may refer to a subscription request for monitoring event services to the HSS (310).

At step 6: At step 322, the HSS (310) may send a MONTE subscription create response to the SCEF (306). In an embodiment, the MONTE subscription create response may include access to or approvals for monitoring events.

At step 7: At step 324, the SCEF (306) may send an event exposure subscribe response to the NEF (304) over the interface. In an embodiment, the event exposure subscribe response may include access to or approvals for monitoring events.

At steps 7.1 and 7.2: the NEF (304) is configured to receive an error message from the SCEF (306). In an embodiment, the NEF (304) is configured to perform an error handling procedure after receiving the error message. In an embodiment, the error handling procedure includes determining if the error message is received due to a communication failure between the NEF (304) and the SCEF (306). In an embodiment, the error handling procedure includes determining if the error message is received due to the event monitoring request from the AF (302). In an embodiment, the NEF (304) is configured to send an error response message to the AF (302) when it is determined that the error message is received due to the event monitoring request from the AF (302). In an embodiment, the NEF (304) is configured to retry sending the event monitoring request to the SCEF (306) when it is determined that the error message is received due to the communication failure between the NEF (304) and the SCEF (306).

At step 8: At step 326, the NEF (304) may send the event exposure subscribe response to the AF (302). In examples, the event exposure subscribe response may refer to a response comprising access or approvals for monitoring events including UDM events, HSS events, etc., associated with the UE.

In an embodiment, the UDM (308) may forward the subscription to an AMF (based on the monitoring event) with type and maxReports and an expiry time. The AMF may share its identifier (ID) with the UDM (308) during the UE attach procedure in a 5GC in Namf_EventExposure_subscribe. In an aspect, the maxReports refers to a maximum number of reports that can be generated by the subscribed event. The expiry time is the time after which the subscribed event(s) shall stop generating reports and the subscription becomes invalid. The “Namf_EventExposure_subscribe” enables a network function (NF) to subscribe to event notifications on its own or behalf of another NF and get notified about an event. If the UE (104) attaches in the 5G network, the UDM (308) may provision the MONTE of the AMF as per a public data network (PDN) connectivity request. While, in case the UE (104) attaches in the 4G, the HSS (310) may create the MONTE on the MME based on the existing PDN connectivity request.

In an embodiment, the AMF may send the MONTE configuration response to the UDM (308) and the UDM (308) may forward the MONTE configuration response to the NEF (304). For EPC, the HSS (310) may forward the subscription to the MME based on an MME ID shared to the HSS (310) during the UE attach procedure. The HSS (310) may forward the subscription response to the UDM (308) after receiving event subscription response from the MME. Further, the UDM (308) may forward the event exposure subscription response to the NEF (304).

In an embodiment, in case of a MONTE delete request from the AF (302), the converged NEF may initiate a delete request towards the UDM (308) and the HSS (310). If the UE (104) is already attached in 4G, the NEF (304) may forward the request to the SCEF (306) over the interface and the SCEF (306) may send a delete request to HSS (310). The HSS (310) may initiate an insert subscription data request-insert subscription data answer (IDR-IDA) towards the MME based on the MONTE create request's response (if creation was successful or not). In an aspect, the IDR is used to insert or update subscriber information in the network's database. This request is commonly used when activating new subscriptions, updating subscriber data, or performing other administrative tasks related to subscriber management. In an aspect, the IDA refers to a response from the network's subscriber database (e.g., the HSS) confirming the successful insertion or update of subscriber data. This response is generated in reply to the IDR and provides feedback on the outcome of the operation. If the UE (104) is detached from the network, then the HSS (310) may update the MONTEs in the MME via an update location request/update location answer (ULR/ULA) when the UE (104) reattaches to the network.

In an embodiment, in case of the UE (104) attachment in fifth generation network (5G), the NEF (304) may send an unsubscribe request to the UDM (308), and the UDM (308) may initiate “Namf_EventExposure_Unsubscribe” towards the AMF (or unsubscribe to SMF) to remove an existing subscription. In an aspect, the “Namf_EventExposure_Unsubscribe” enables a network function (NF) to unsubscribe to event notifications on its own or behalf of another NF for any event notification. The NEF (304) may initiate the delete request on the UDM (308) and the SCEF (306) may initiate the delete request towards the HSS (310).

In an embodiment, for 5GC, the AMF may detect the event based on the UE (104) availability and send a notification to the NEF (304) based on a converged NEF-ID received from the UDM (308) during the subscription. The converged NEF-ID may be a call-back for forwarding the request to converged NEF clusters of multiple instances. In case of the MONTE report flow via a service communication proxy (SCP), the converged NEF-ID may be visible in a binding header. For EPC, the MME may detect the event based on the UE (104) and send the notification to the SCEF (306) based on the converged NEF-ID received from the HSS (310). Further, the SCEF (306) may forward a notification to the NEF (304) over interface. The converged NEF-ID may be commonly used by the NEF (304) and the SCEF (306) in the EPC and the 5GC. The converged NEF-ID may be routable in both the 4G and the 5G networks.

In an exemplary embodiment, the present invention discloses a method for monitoring an event in a non-clustered network. The method comprising receiving, by a network exposure function (NEF), an event monitoring request from an application function (AF). The method comprising responsive to receiving the event monitoring request, communicating, by the NEF, the event monitoring request to a service capabilities exposure function (SCEF) and a unified data management (UDM) event monitoring request to a UDM. The method comprising responsive to the UDM event monitoring request, receiving, by the NEF a UDM event monitoring response from the UDM and responsive to the event monitoring request, receiving, by the NEF, an event monitoring response from the SCEF. The method comprising receiving, by the AF, the event monitoring response from the NEF in response to the event monitoring request to allow monitoring of the event.

In an embodiment, the event monitoring request is communicated from the NEF to the SCEF over an interface between the NEF and the SCEF.

In an embodiment, the event monitoring response is communicated from the SCEF to the NEF over the interface.

In an embodiment, the NEF is configured to operate in an asynchronous mode when the UDM and a home subscriber server (HSS) are a part of the non-clustered network and fail to support internetworking.

In an embodiment, the NEF communicates the event monitoring request to the SCEF and the UDM simultaneously when the NEF is configured in the asynchronous mode.

In an embodiment, the method comprising responsive to receiving the event monitoring request, communicating, by the SCEF, a monitoring event subscription create request to the HSS and responsive to the monitoring event subscription create request, receiving, by the SCEF, a monitoring event subscription response from the HSS.

In an embodiment, the NEF is configured to receive a first monitoring event identifier (ID) and a second monitoring event ID, from the HSS and the UDM, respectively.

In an embodiment, the NEF is configured to receive an error message from the UDM/HSS, or the SCEF.

In an embodiment, the NEF is configured to perform an error handling procedure after receiving the error message.

In an embodiment, the error handling procedure includes determining if the error message is received due to a communication failure between the NEF and the SCEF or the UDM respectively.

In an embodiment, the error handling procedure includes determining if the error message is received due to the event monitoring request from the AF.

In an embodiment, the NEF is configured to send an error response message to the AF when it is determined that the error message is received due to the event monitoring request from the AF.

In an embodiment, the NEF is configured to retry sending the event monitoring request to the SCEF when it is determined that the error message is received due to the communication failure between the NEF and the SCEF.

In an embodiment, the NEF is configured to retry sending the event monitoring request to the UDM when it is determined that the error message is received due to the communication failure between the NEF and the UDM.

In an exemplary embodiment, the present invention discloses a system for monitoring an event in a non-clustered network. The system comprising a receiving unit configured to receive an event monitoring request, a database configured to store the event monitoring request, and a processing unit coupled to the receiving unit and the database. The processing unit is configured for receiving, by a network exposure function (NEF), an event monitoring request from an application function (AF). The processing unit is configured for responsive to receiving the event monitoring request, communicating, by the NEF, the event monitoring request to a service capabilities exposure function (SCEF) and a unified data management (UDM) event monitoring request to a UDM. The processing unit is configured for responsive to the UDM event monitoring request, receiving, by the NEF a UDM event monitoring response from the UDM and responsive to the event monitoring request, receiving, by the NEF, an event monitoring response from the SCEF. The processing unit is configured for receiving, by the AF, the event monitoring response from the NEF in response to the event monitoring request to allow monitoring of the event.

In an embodiment, the event monitoring request is communicated from the NEF to the SCEF over an interface between the NEF and the SCEF.

In an embodiment, the event monitoring response is communicated from the SCEF to the NEF over the interface.

In an embodiment, the NEF is configured to operate in an asynchronous mode when the UDM and a home subscriber server (HSS) are a part of the non-clustered network and fail to support internetworking.

In an embodiment, the NEF communicates the event monitoring request to the SCEF and the UDM simultaneously when the NEF is configured to operate in the asynchronous mode.

In an embodiment, responsive to receiving the event monitoring request, communicate, by the SCEF, a monitoring event subscription create request to the HSS and responsive to the monitoring event subscription create request, receive, by the SCEF, a monitoring event subscription response from the HSS.

In an embodiment, the NEF is configured to receive a first monitoring event identifier (ID) and a second monitoring event ID, from the HSS and the UDM, respectively.

In an embodiment, the NEF is configured to receive an error message from the UDM/HSS, or the SCEF.

In an embodiment, the NEF is configured to perform an error handling procedure after receiving the error message.

In an embodiment, the error handling procedure includes determining if the error message is received due to a communication failure between the NEF and the SCEF or the UDM respectively.

In an embodiment, the error handling procedure includes determining if the error message is received due to the event monitoring request from the AF.

In an embodiment, the NEF is configured to send an error response message to the AF when it is determined that the error message is received due to the event monitoring request from the AF.

In an embodiment, the NEF is configured to retry sending the event monitoring request to the SCEF when it is determined that the error message is received due to the communication failure between the NEF and the SCEF.

In an embodiment, the NEF is configured to retry sending the event monitoring request to the UDM when it is determined that the error message is received due to the communication failure between the NEF and the UDM.

In an exemplary embodiment, the present invention discloses user equipment (UE) communicatively coupled with a non-clustered network configured for monitoring an event. The coupling comprises receiving, by the non-clustered network, a connection request by the UE. The coupling comprises sending, by the non-clustered network an acknowledgment of the connection request to the UE and transmitting a plurality of signals in response to the connection request. The non-clustered network comprising one or more network elements for monitoring events. In an aspect, the one or more network elements include a network exposure function (NEF) and a service capability exposure function (SCEF). The NEF is configured to send an event monitoring request to a service capabilities exposure function (SCEF), and a unified data management (UDM) event monitoring request to a UDM. The event monitoring request to the SCEF is communicated through an interface between the NEF and the SCEF. A UDM event monitoring response is communicated to the NEF from the UDM responsive to the UDM event monitoring request. An event monitoring response is communicated from the SCEF to the NEF via the interface, responsive to the event monitoring request, to allow monitoring of events associated with the UE.

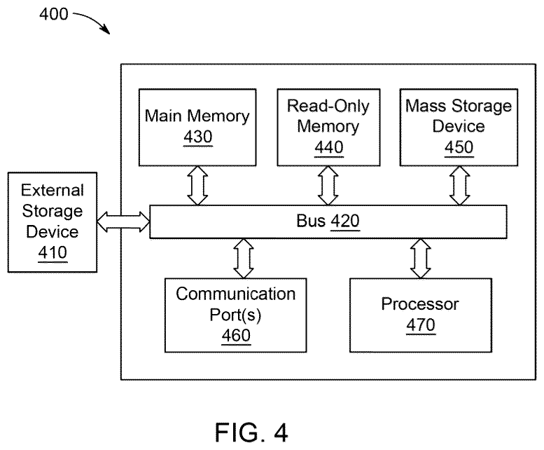

FIG. 4 illustrates an exemplary computer system (400) in which or with which embodiments of the present disclosure may be implemented.

As shown in FIG. 4, the computer system (400) may include an external storage device (410), a bus (420), a main memory (430), a read-only memory (440), a mass storage device (450), a communication port(s) (460), and a processor (470). A person skilled in the art will appreciate that the computer system (400) may include more than one processor and communication ports. The processor (470) may include various modules associated with embodiments of the present disclosure. The communication port(s) (460) may be any of an RS-232 port for use with a modem-based dialup connection, a 10/100 Ethernet port, a Gigabit or 10 Gigabit port using copper or fiber, a serial port, a parallel port, or other existing or future ports. The communication ports(s) (460) may be chosen depending on a network, such as a Local Area Network (LAN), Wide Area Network (WAN), or any network to which the computer system (400) connects.

In an embodiment, the main memory (430) may be Random Access Memory (RAM), or any other dynamic storage device commonly known in the art. The read-only memory (440) may be any static storage device(s) e.g., but not limited to, a Programmable Read Only Memory (PROM) chip for storing static information e.g., start-up or basic input/output system (BIOS) instructions for the processor (470). The mass storage device (450) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (420) may communicatively couple the processor(s) (470) with the other memory, storage, and communication blocks. The bus (420) may be, e.g., a Peripheral Component Interconnect PCI)/PCI Extended (PCI-X) bus, Small Computer System Interface (SCSI), Universal Serial Bus (USB), or the like, for connecting expansion cards, drives, and other subsystems as well as other buses, such a front side bus (FSB), which connects the processor (470) to the computer system (400).

In another embodiment, operator and administrative interfaces, e.g., a display, keyboard, and cursor control device may also be coupled to the bus (420) to support direct operator interaction with the computer system (400). Other operator and administrative interfaces can be provided through network connections connected through the communication port(s) (460). Components described above are meant only to exemplify various possibilities. In no way should the aforementioned exemplary computer system (400) limit the scope of the present disclosure.

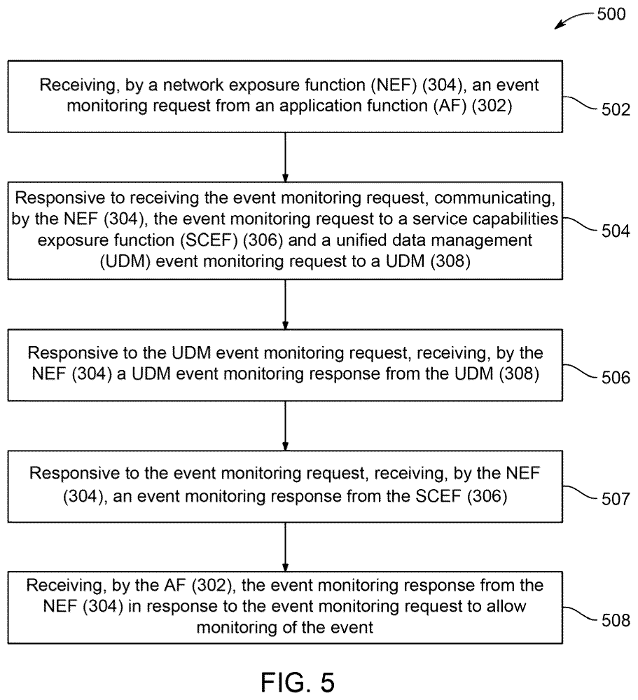

FIG. 5 illustrates an exemplary flow diagram for a method for monitoring an event in a non-clustered network.

At step 502, the method comprising receiving, by a network exposure function (NEF) (304), an event monitoring request from an application function (AF) (302).

At step 504, the method comprising communicating, by the NEF (304), the received event monitoring request to a service capabilities exposure function (SCEF) (306), and a unified data management (UDM) event monitoring request to a UDM (308), responsive to receiving the event monitoring request.

At step 506, the method comprising responsive to the UDM event monitoring request, receiving, by the NEF (304) a UDM event monitoring response from the UDM (308).

At step 507, the method comprising responsive to the event monitoring request, receiving, by the NEF (304), an event monitoring response from the SCEF (306).

At step 508, the method comprising receiving, by the AF (302), the event monitoring response from the NEF (304) in response to the event monitoring request to allow monitoring of the event.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

In an aspect, the present disclosure provides a system and a method for monitoring non-clustered events in a network using a converged network exposure function (CNEF). In an aspect, the present disclosure improves the network capabilities and system. In an aspect, the present disclosure provides a robust system for communication and nodes management.

In an aspect, the present disclosure can be implemented within a 5G communication network or with various network elements that may involve various algorithms, protocols, or mechanisms.

### ADVANTAGES OF THE INVENTION

The present disclosure provides a system and a method for monitoring non-clustered events in a network using a converged network exposure function (CNEF).

The present disclosure provides a system and a method where a network exposure function (NEF) is configured in an asynchronous mode to send a monitoring event (MONTE) request to a service capabilities exposure function (SCEF) and a unified data manager function (UDM) simultaneously.

The present disclosure provides a system and a method where the NEF is configured to send a request to the SCEF internally over an interface and initiate an UDM event exposure subscribe request.

The present disclosure improves the network capabilities and system.

The present disclosure provides a robust system for communication and nodes management.

1. A method for monitoring an event in a non-clustered network, the method comprising:
receiving, by a network exposure function (NEF), an event monitoring request from an application function (AF);
responsive to receiving the event monitoring request, communicating, by the NEF, the event monitoring request to a service capabilities exposure function (SCEF) and a unified data management (UDM) event monitoring request to a UDM;
responsive to the UDM event monitoring request, receiving, by the NEF a UDM event monitoring response from the UDM;
responsive to the event monitoring request, receiving, by the NEF, an event monitoring response from the SCEF;
receiving, by the AF, the event monitoring response from the NEF in response to the event monitoring request to allow monitoring of the event.

2. (canceled)

3. (canceled)

4. (canceled)

5. (canceled)

6. The method as claimed in claim 1, further comprising:
responsive to receiving the event monitoring request, communicating, by the SCEF, a monitoring event subscription create request to the HSS; and
responsive to the monitoring event subscription create request, receiving, by the SCEF, a monitoring event subscription response from the HSS.

7. (canceled)

8. The method as claimed in claim 1, wherein the NEF is configured to receive an error message from the UDM/HSS, or the SCEF.

9. The method as claimed in claim 8, wherein the NEF is configured to perform an error handling procedure after receiving the error message.

10. The method as claimed in claim 9, wherein the error handling procedure includes determining if the error message is received due to a communication failure between the NEF and the SCEF or the UDM respectively.

11. The method as claimed in claim 9, wherein the error handling procedure includes determining if the error message is received due to the event monitoring request from the AF.

12. The method as claimed in claim 11, wherein the NEF is configured to send an error response message to the AF when it is determined that the error message is received due to the event monitoring request from the AF.

13. The method as claimed in claim 10, wherein the NEF is configured to retry sending the event monitoring request to the SCEF when it is determined that the error message is received due to the communication failure between the NEF and the SCEF.

14. The method as claimed in claim 10, wherein the NEF is configured to retry sending the event monitoring request to the UDM when it is determined that the error message is received due to the communication failure between the NEF and the UDM.

15. A system for monitoring an event in a non-clustered network, the system comprising:
a receiving unit configured to receive an event monitoring request;
a database configured to store the event monitoring request;
a processing unit coupled to the receiving unit and the database, wherein the processing unit is configured for:
receiving, by a network exposure function (NEF), the event monitoring request from an application function (AF);
responsive to receiving the event monitoring request, communicating, by the NEF, the event monitoring request to a service capabilities exposure function (SCEF), and a unified data management (UDM) event monitoring request to a UDM;
responsive to the UDM event monitoring request, receiving, by the NEF a UDM event monitoring response from the UDM;
responsive to the event monitoring request, receiving, by the NEF, an event monitoring response from the SCEF;
receiving, by the AF, the event monitoring response from the NEF in response to the event monitoring request to allow monitoring of the event.

16. (canceled)

17. (canceled)

18. (canceled)

19. (canceled)

20. The system as claimed in claim 15, further configured to:
responsive to receiving the event monitoring request, communicate, by the SCEF, a monitoring event subscription create request to the HSS; and
responsive to the monitoring event subscription create request, receive, by the SCEF, a monitoring event subscription response from the HSS.

21. (canceled)

22. The system as claimed in claim 15, wherein the NEF is configured to receive an error message from the UDM/HSS, or the SCEF.

23. The system as claimed in claim 22, wherein the NEF is configured to perform an error handling procedure after receiving the error message.

24. The system as claimed in claim 23, wherein the error handling procedure includes determining if the error message is received due to a communication failure between the NEF and the SCEF or the UDM respectively.

25. The system as claimed in claim 23, wherein the error handling procedure includes determining if the error message is received due to the event monitoring request from the AF.

26. The system as claimed in claim 25, wherein the NEF is configured to send an error response message to the AF when it is determined that the error message is received due to the event monitoring request from the AF.

27. The system as claimed in claim 24, wherein the NEF is configured to retry sending the event monitoring request to the SCEF when it is determined that the error message is received due to the communication failure between the NEF and the SCEF.

28. The system as claimed in claim 24, wherein the NEF is configured to retry sending the event monitoring request to the UDM when it is determined that the error message is received due to the communication failure between the NEF and the UDM.

29. A user equipment (UE) communicatively coupled with a non-clustered network, the coupling comprises steps of:
receiving, by the non-clustered network a connection request from the UE;
sending, by the non-clustered network, an acknowledgment of the connection request to the UE; and
transmitting a plurality of signals in response to the connection request, wherein the non-clustered network comprising one or more network elements configured for performing a method for monitoring an event as claimed in claim 1.

30. A computer program product comprising a non-transitory computer-readable medium comprising instructions that, when executed by one or more processors, cause the one or more processors to perform method for monitoring an event in a non-clustered network, the method comprising:
receiving, by a network exposure function (NEF), an event monitoring request from an application function (AF);
responsive to receiving the event monitoring request, communicating, by the NEF, the event monitoring request to a service capabilities exposure function (SCEF) and a unified data management (UDM) event monitoring request to a UDM;
responsive to the UDM event monitoring request, receiving, by the NEF a UDM event monitoring response from the UDM;
responsive to the event monitoring request, receiving, by the NEF, an event monitoring response from the SCEF;
receiving, by the AF, the event monitoring response from the NEF in response to the event monitoring request to allow monitoring of the event.
